(19) United States
(12) Patent Application Publication
(10) Pub. No.: US 2026/0359378 A1
(43) Pub. Date: Nov. 12, 2026

(54) EVENT DETECTION USING FUZZY SETS AND DEMPSTER-SHAFER THEORY

(71) Applicant: Aurora Engineering LLC, Wilton, NH (US)

(72) Inventors: Alexander BARRIE, Irvine, CA (US); Miles BENGTSON, Iron Station, NC (US); Liam GREENLEE, Silver Spring, MD (US); Joseph PATTON, Westbrook, ME (US)

(73) Assignee: Aurora Engineering LLC, Wilton, NH (US)

(21) Appl. No.: 19/713,582

(22) Filed: Jun. 18, 2026

Related U.S. Application Data
(60) Provisional application No. 63/791,330, filed on Apr. 18, 2025.

(51) Int. Cl. G06F 17/10; G06F 7/02

(52) U.S. Cl. CPC G06F 17/10; G06F 7/02

(57) ABSTRACT

The Module for Event Driven Operations on Spacecraft (MEDOS) is a framework for real time operational decisions based on detected events from on-board measurements. MEDOS calculates derived parameters, which are physically meaningful and relevant to a mission planner. These derived parameters are then compared, using fuzzy sets, to typical (for example, published) values of the given parameter and a confidence is produced that the event in question has occurred. Operational responses can then be triggered to detected events. Because MEDOS utilizes processes well understood and developed by the community in question, and due to the nature of events being presented as a likelihood rather than a definitive, it achieves a level of trust that can enable future mission infusion for operational space missions, and terrestrial vehicles.

### CROSS-REFERENCE TO RELATED APPLICATIONS

This application claims priority to prior U.S. Provisional Patent Application No. 63/791,330, filed February Apr. 18, 2025, the entire content of which is incorporated herein by reference.

### BACKGROUND

### 1. Field of Disclosure

Generally, exemplary embodiments of the present disclosure relate to apparel that provide for carrying of objects by a person wearing the apparel, and in particular to articles of clothing that comprise a waistband.

### 2. Description of Related Art

Operations engineers face the task of maintaining successful operation of a spacecraft based on extremely limited information. This task becomes even more complicated when considering lag time between contacts, the light-time delay of bidirectional communications, and the prospect of multiple spacecraft operating simultaneously. Imagine a swarm of 100 satellites near Jupiter, and the prospect of manually detecting, assessing, and responding to every potential event on a spacecraft quickly approaches a point of impossibility. Simple pre-programmed time tagged commands become increasingly burdensome in multi-spacecraft missions, particularly when trying to target ephemeral events in space that are difficult to predict with any accuracy.

As outlined in Freed, M., Scassero, M., and Rummel, C., “Trusted autonomy for spaceflight systems,” 1st Space Exploration Conference: Continuing the Voyage of Discovery, 2005. https://doi.org/10.1109/SPC.2005.1504244. and Abbass, H. A., Scholz, J., and Reid, D. J., Foundations of trusted autonomy, Springer Nature, 2018. https://doi.org/10.1007/978-3-319-77733-8. the entire disclosures of which are incorporated herein by reference, autonomy is an admirable goal, and indeed NASA has outlined a technology roadmap toward spacecraft autonomy (see Ambrose, R., Nesnas, I., Chandler, F., Allen, B., Fong, T., Matthies, L., and Mueller, R., “NASA technology roadmaps: TA 4: Robotics and autonomous systems,” Tech. rep., 2015, the entire disclosures of which are incorporated herein by reference), but widespread adoption remains elusive as the system must be trusted in order to be adopted by flight missions. Spacecraft commanding and operational planning is typically performed via preprogrammed time sequences (see Starin, S. R., Vess, M. F., Kenney, T. M., Maldonado, M. D., and Morgenstern, W. M., “Fault detection and correction for the Solar Dynamics Observatory attitude control system,” AAS 2008 Guidance and Control (GN&C) Conference, 2007, the entire disclosure of which is incorporated herein by reference). In some ways, this in itself is autonomous operation: a sequence of commands is loaded that run automatically at a predefined time. This system is not responsive, or adaptive, however.

The roots of event driven operations, however, have long been present. Many spacecraft have had fault detection and correction (FDC) systems that respond to specific events and issue a corrective action (see Welch, R., “Autonomous failure detection and correction on Landsat-4,” Guidance and Control Conference, 1983, the entire disclosure of which is incorporated herein by reference). Similar automated systems are often in place for routine tasks such as heater cycling (see Williams, T., Shulman, S., Ottenstein, N., Palmer, E., Riley, C., Letourneau, S., Hollister, J., Tedla, Y., and Godine, D., “Operational techniques for dealing with long eclipses during the MMS extended mission,” 2020 IEEE Aerospace Conference, IEEE, 2020, pp. 1-12, the entire disclosure of which is incorporated herein by reference). The Aeronomy of Ice in the Mesosphere (AIM) spacecraft took this a step further when it lost reliable ground communications and had to automate almost all onboard operations, such as eclipse operations based on an event driven detection of eclipse exit (see McCabe, D., Ryan, S., Welch, D., and Fulmer, J., “AIM Autonomy Development-Long Term Care for a Deaf Spacecraft,” SpaceOps 2008 Conference, 2008, p. 3450, the entire disclosure of which is incorporated herein by reference). Members of our team were themselves intimately involved in the effort to implement this onboard operations plan for AIM. There have been some failures along the way, such as NASA's DART spacecraft failing an automated docking procedure (see Croomes, S., “Overview of the DART mishap investigation results,” 2006, the entire disclosure of which is incorporated herein by reference), however autonomous maneuver planning was successfully demonstrated by NASA's EO-1 spacecraft (see Folta, D., and Hawkins, A., “Results of NASA's first autonomous formation flying experiment: earth observing-1 (EO-1),” AIAA/AAS Astrodynamics Specialist Conference and Exhibit, 2002, the entire disclosure of which is incorporated herein by reference). The James Webb Space Telescope (JWST) program noted that the Hubble Space Telescope (HST) would consistently lose time when a particular measurement could not initialize. Rather than waiting for the next schedule operation to start, JWST detects that failed measurement, and immediately moves on to the next one (Adler, D. S., Wymer, K. B., Logue, R. M., and Hesman, B. E., “Science planning and scheduling of the James Webb Space Telescope,” Observatory Operations: Strategies, Processes, and Systems VIII, Vol. 11449, SPIE, 2020, pp. 233-245. https://doi.org/10.1117/12.2560336., the entire disclosure of which is incorporated herein by reference).

With the advancement of artificial intelligence (AI) and machine learning (ML), a myriad of algorithms have been proposed for spacecraft autonomy. A host of studies have been performed in the field of anomaly/outlier detection. (See Su, Y., Zhao, Y., Niu, C., Liu, R., Sun, W., and Pei, D., “Robust anomaly detection for multivariate time series through stochastic recurrent neural network,” Proceedings of the 25th ACM SIGKDD international conference on knowledge discovery & data mining, 2019, pp. 2828-2837; Hundman, K., Constantinou, V., Laporte, C., Colwell, I., and Soderstrom, T., “Detecting spacecraft anomalies using lstms and nonparametric dynamic thresholding,” Proceedings of the 24th ACM SIGKDD international conference on knowledge discovery & data mining, 2018, pp. 387-395. https://doi.org/10.1145/3219819.3219886.; and Yu, J., Zhang, Y., Li, X., Wang, X., and Zhang, L., “Telemetry Data-Based Spacecraft Anomaly Detection With Spatial-Temporal Generative Adversarial Networks,” IEEE Transactions on Instrumentation and Measurement, Vol. 70, 2021, pp. 1-9. https://doi.org/10.1109/TIM.2020.3034881., the entire disclosures of which are incorporated herein by reference). The use of AI/ML for maneuver planning has matured slightly further, with the work of Schaub and others (see Harris, A., Teil, T., and Schaub, H., “Spacecraft decision-making autonomy using deep reinforcement learning,” 29th AAS/AIAA spaceflight mechanics meeting, hawaii, 2019. https://doi.org/10.2514/6.2019-2111.; Harris, A., Valade, T., Teil, T., and Schaub, H., “Generation of spacecraft operations procedures using deep reinforcement learning,” Journal of Spacecraft and Rockets, Vol. 59, No. 2, 2022, pp. 611-626. https://doi.org/10.2514/1.SC007341.; Elkins, J., Sood, R., and Rumpf, C., “Adaptive continuous control of spacecraft attitude using deep reinforcement learning,” 2020 AAS/AIAA Astrodynamics Specialist Conference, AIAA, 2020. https://doi.org/10.2514/6.2020-3641.; and Federici, L., Benedikter, B., and Zavoli, A., “Machine Learning Techniques for Autonomous Spacecraft Guidance during Proximity Operations,” AIAA Scitech 2021 Forum, 2021. https://doi.org/10.2514/6.2021-0411., the entire disclosures of which are incorporated herein by reference), notably on the NASA Starling mission (see Adams, C., Kempa, B., Iatauro, M., Frank, J., and Vaughan, W., “An Overview of Distributed Spacecraft Autonomy at NASA Ames,” Proceedings of the Small Satellite Conference, Utah State University, 2023, the entire disclosure of which is incorporated herein by reference). Recently, the OPS-SAT satellite has utilized a trained AI/ML algorithm to detect target areas of interest for science acquisition (see Labreche, G., Genta, G., Pilz, S., Reinert, E., and Kroes, R., “Artificial Intelligence for Autonomous Planning and Scheduling of Image Acquisition with the SmartCam App On-Board the OPS-SAT Spacecraft,” AIAA SCITECH 2022 Forum, 2022. https://doi.org/10.2514/6.2022-0541., the entire disclosure of which is incorporated herein by reference) and da Silva (see Da Silva, D. E., Barrie, A. C., Shuster, J. R., Schiff, C., Attie, R., Gershman, D. J., and Giles, B. L., “Automatic Region Identification Over the MMS Orbit by Partitioning nT Space,” arXiv preprint arXiv:2003.08822, 2020; and Innocenti, M. E., Moradi, M., Eriksson, S., and Vaivads, A., “Unsupervised classification of simulated magnetospheric regions,” Annales Geophysicae, Vol. 39, No. 5, 2021. https://doi.org/10.5194/angeo-39-641-2021., the entire disclosures of which are incorporated herein by reference) have used ML for region classification and boundary detection.

Historically, autonomous spacecraft operations have therefore been split into two major camps: rule based, and statistical based optimizations. Strict, rule based systems are fairly straightforward to implement and can be used effectively to respond to specific events for which they have been programmed. For example, if a temperature drops too low then turn on a heater: IF (A AND B AND C) THEN D. But what if parameters skirt the edge of a decision point? (A AND B AND almost but not quite C). Rule based systems cannot be expected to understand every possible permutation of telemetry that they encounter, particularly when most spacecraft have thousands of telemetry points.

Statistical systems, often based on machine learning (ML), use examples of known scenarios to train a system to recognize them. If the system sees 1000 examples of an event, it can learn to recognize the signatures of that event (see Lu, D., and Weng, Q., “A survey of image classification methods and techniques for improving classification performance,” International journal of Remote sensing, Vol. 28, No. 5, 2007, pp. 823-870. https://doi.org/10.1080/01431160600776957., the entire disclosures of which are incorporated herein by reference). Flight missions, however, often cannot sacrifice mission time to collecting training data. Even when data are available, the trained system is seen as a black box that is not grounded in a physical understanding of the system and an operations engineer is not able to tune or modify the model as the mission evolves.

### SUMMARY OF THE DISCLOSURE

Exemplary embodiments of the present disclosure address at least the above noted drawback by providing a system comprising

According to exemplary implementations of the disclosed embodiments a Module for Event Driven Operations on Spacecraft (MEDOS) realizes an approach where an operations engineer is put on the spacecraft. In an example implementation, MEDOS takes raw telemetry and fuses them together into extracted features, creating physically meaningful derived quantities that an engineer understands. For example, turning voltages and decay times into “methane concentration”, or turning count rates and field vectors into “plasma density”. Then, for example using fuzzy sets, MEDOS compares the physical parameters to generalized event definitions that scientists and engineers can use in their analysis, for example gathered from published studies, flight heritage, and subject matter expertise, such as for example and without limitation—when the plasma density jumps and the magnetic field reverses direction, it means we crossed the magnetopause.

In a further exemplary implementation a MEDOS can then be used to detect all manner of events and respond to them in real time, including for example and without limitation any one, or combination of. Boundary crossings can be used to trigger a change in operational mode; Subtle signatures in science data, that can potentially be missed by human review, can be detected and flagged for downlink; and dangerous event, such as a coronal mass ejection (CME) can be trigger a safing event in a fleet of satellites.

According to exemplary implementations of the disclosed embodiments, MEDOS can be configure to analyze the ambient environment in real time, make an assessment as to what is occurring, and respond to it in a way consistent with the response of an operations engineer. MEDOS can be deployed in large constellations, far from human assistance, and can incorporate data from other spacecraft into the decision making process (for example, a lead spacecraft's measurement may be used to compute a gradient, or used as an early indication of an upcoming event.) It can be used to rank high priority data, trigger opportunistic measurements, change operating modes, monitor health and safety, perform region classification, or many other operations that can be triggered by in-situ event detection. In short, MEDOS is a step forward towards the goal of true trusted autonomy.

In another exemplary implementation, MEDOS can be run through NASA's core Flight System (cFS) (see, for example, and without limitation, McComas, D., “NASA/GSFC's Flight Software Core Flight System,” Flight Software WorkshopFlight Workshop, 2012, the entire disclosure of which is incorporated herein by reference), the Robot Operating System (ROS) (see, for example, and without limitation, Quigley, M., Conley, K., Gerkey, B., Faust, J., Foote, T., Leibs, J., Wheeler, R., and Ng, A. Y., “ROS: an open-source Robot Operating System,” ICRA workshop on open source software, Vol. 3, Kobe, Japan, 2009, p. 5, the entire disclosures of which are incorporated herein by reference), or as a custom C library which can be wrapped into other frameworks. In further exemplary implementations, MEDOS can also be implemented in JPL's F′ (see, for example, and without limitation, Bocchino, R., Canham, T., Watney, G., Reder, L., and Levison, J., “F Prime: an open-source framework for small-scale flight software systems,” Software in Aerospace, Vol. 1, No. 1, 2018, pp. 1-14. https://doi.org/10.2514/1.S00011., the entire disclosures of which are incorporated herein by reference). In still further exemplary implementations, MEDOS has been validated to NASA Technical Readiness Level 6 (TRL-6) via flatsat testing.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is an example diagrammatic illustration of methodology and systems according to example implementations of example embodiments of the disclosure.

FIG. 2 is an example graphical illustration to facilitate understanding of example implementations of example embodiments of the disclosure.

FIG. 3 is an example graphical illustration to further facilitate understanding of example implementations of example embodiments of the disclosure.

### DETAILED DESCRIPTION OF EXEMPLARY EMBODIMENTS OF DISCLOSURE

The matters exemplified in this description are provided to assist in a comprehensive understanding of exemplary embodiments of the disclosure. Accordingly, those of ordinary skill in the art will recognize that various changes and modifications of the embodiments described herein can be made without departing from the scope and spirit of the disclosure. Also, descriptions of well-known functions and constructions are omitted for clarity and conciseness.

As would be readily appreciated by skilled artisans in the relevant art, while descriptive terms such as “events”, “telemetry”, “extraction”, “detection”, “range”, “pitch”, “angle”, “probability”, “consisting”, “comprising”, “rule”, “microinjections”, “panel”, “space”, “orbit”, “trajectory”, “streaming”, “counterstreaming”, “small”, “large”, “transform”, “person”, “focal”, “elements”, “magnetosphere”, “autonomous”, “submersible”, “subterranean”, “environment”, “physically meaningful”, “key”, and others are used throughout this specification to facilitate understanding, it is not intended to limit any components that can be used in combinations or individually to implement various aspects of the embodiments of the present disclosure. Also, exemplary embodiments and/or exemplary implementations thereof described in the disclosure may be referenced as “MEDOS” to facilitate understanding of the disclosure, or as a concise point of reference, but not as a limitation of the disclosed structural and/or functional features.

To facilitate understanding of the disclosure, but not as a limitation of the disclosed structural and/or functional feature, data from NASA's Magnetospheric Multiscale (MMS) mission (see Burch, J., Moore, T., Torbert, R., and Giles, B., “Magnetospheric multiscale overview and science objectives,” Space Science Reviews, Vol. 199, 2016, pp. 5-21. https://doi.org/10.1007/s11214-016-0267-x., the entire disclosure of which is incorporated herein by reference) is used to illustrate examples of the utility of MEDOS and is organized as follows: description of the MEDOS algorithm according to example implementations of example embodiments of the disclosure, showcases of the verification and validation approach according to example implementations of example embodiments of the disclosure, and non-limiting summary and still further example implementations of example embodiments of the disclosure.

### I. Example MEDOS Algorithms

According to exemplary implementations of disclosed exemplary embodiments MEDOS algorithm and software can comprise, or consist of, two stages:
1) A derived telemetry feature extractor that fuses multiple telemetry streams together into a physically meaningful quantity.
2) Event detection using fuzzy sets to determine a confidence that a given event is occurring.

In example implementations, once an event has been detected, the spacecraft operations team may choose to assign an associated action in response to the given event—change operating modes, tune a setting, prioritize a data segment, and so forth.

### A. Derived Telemetry Via Feature Extraction

In an exemplary implementation, derived telemetry can be calculated based on user-defined mathematical operations. Source data for the derived telemetry can come from multiple sources:
Raw telemetry
Previously calculated derived telemetry table, which enables analysis of long term trends, variability, waves and frequency analysis, etc.
Ground based loads into a defined memory location (e.g. tabulated parameters, red/yellow limits)
Messages from other spacecraft, real time ground contacts, etc.

According to exempla implementations, features can be extracted into derived telemetry points, per subject matter expert (SME) definition. For example, the purpose of this step is to encode conversions that typically happen on the ground onto the spacecraft. A non-limiting illustration of this process, is described with reference to an example of detecting microinjection events in the magnetosphere—a process described in detail by Nykyri et al. (see for example and without limitation Nykyri, K., Johnson, J., Kronberg, E., Turner, D., Wing, S., Cohen, I., Sorathia, K., Ma, X., Burkholder, B., Reeves, G., and Fennell, J., “Magnetospheric multiscale observations of the source region of energetic electron microinjections along the duskside, high-latitude magnetopause boundary layer,” Geophysical Research Letters, Vol. 48, No. 9, 2021, p. e2021GL092466. https://doi.org/10.1029/2021GL092466., the entire disclosure of which is incorporated hereon by reference).

Microinjections can be generally defined by counter-streaming electrons (particles flowing simultaneously parallel and anti-parallel to the magnetic field). The increases in electron flux coincide with troughs of magnetic fluctuations (see for example and without limitation Sarafopoulos, D., “Dispersive and repetitive Pc5 mode microinjections in the inner magnetosphere,” Geophysical research letters, Vol. 29, No. 8, 2002, pp. 26-1. https://doi.org/10.1029/2001GL014384.; and Liou, Y.-L., Nykyri, K., Kavosi, S., and Ma, X., “Statistical Study of the Energetic Electron Microinjections at the High-Latitude Magnetosphere,” Journal of Geophysical Research: Space Physics, Vol. 128, No. 10, 2023, p. e2023JA031595. https://doi.org/10.1029/2023JA031595., the entire disclosures of which are incorporated hereon by reference) in a low frequency range (3-5 minutes).

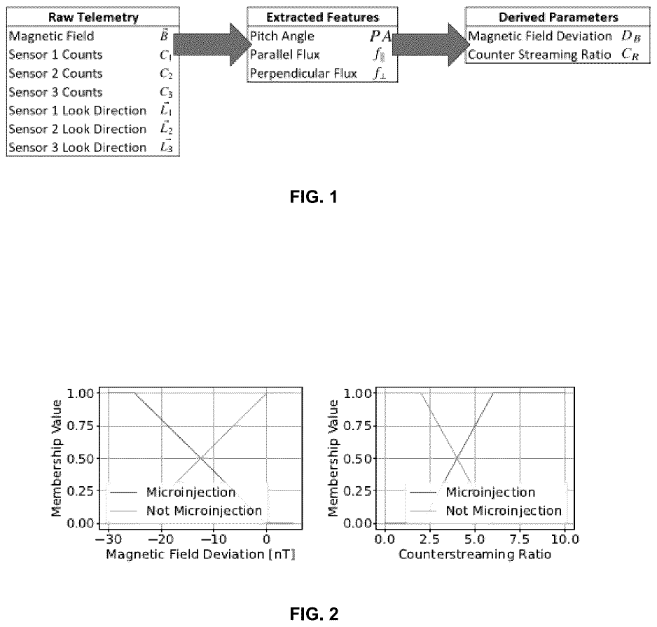

Referring to FIG. 1 shows (abbreviated for clarity) sample raw telemetry, intermediate extracted features, and derived parameters: Raw telemetry (left) with extracted features (center), derived products (right). The mnemonics are notional, but are provided as a shorthand for referencing specific elements. According to example implementations of example embodiments:
1) Each sensor, C, reports a signal (counts) along an associated look direction, L-. The look direction can be mathematically dotted with the local magnetic field vector, B-, to get that sensor's local pitch angle (PA), relative to the magnetic field. These PAs are computed for energetic electrons in the range from 70-600 keV.
2) The flux in the pitch angle bins within 40° of the magnetic field (i.e., PAs<40° and PAs>140°) is summed. This parameter is denoted f∥. Similarly, the flux in the pitch angle bins 40°<PA<140° is summed as f⊥. Then a final derived parameter, counterstreaming ratio, CR is defined as f∥/f⊥.
3) To determine if the magnetic field is in a local trough, an extracted feature is implemented which tracks the average magnetic field over a 10 minute duration. Next, the instantaneous field magnitude is subtracted from this running average to create a magnetic field deviation, DB. If the derived parameter, DB, is negative, the field is in a trough. If it is positive, the field is at a peak.

At this point, the pitch angle distribution has been extracted from the telemetry and two derived parameters have been calculated: a measure of how much signal is counter-streaming along the field, CR, and a measure of the field relative to the past few minutes, DB. In an example implementation, these are the two key physically meaningful features that define the microinjection (see for example and without limitation, Nykyri, K., Johnson, J., Kronberg, E., Turner, D., Wing, S., Cohen, I., Sorathia, K., Ma, X., Burkholder, B., Reeves, G., and Fennell, J., “Magnetospheric multiscale observations of the source region of energetic electron microinjections along the duskside, high-latitude magnetopause boundary layer,” Geophysical Research Letters, Vol. 48, No. 9, 2021, p. e2021GL092466. https://doi.org/10.1029/2021GL092466.).

While these examples are simple calculations, MEDOS derived parameters can be complex in implementation, accounting for computational capability onboard. One of the key benefits of the derived telemetry points is to increase trust in the system. A scientist or SME may not intuitively know how to respond to individual signals, voltages, or telemetry traces, but if they can be converted into a physical quantity, such as “counter-streaming electrons” or “methane concentration”, then the SME can apply their decades of experience in applying an event definition.

### B. Event Detection

According to exemplary implementation of further exemplary embodiments of the present disclosure, in a two-step process, a degree of membership can be defined by the SME for each telemetry point and all the degrees of membership can be combined to generate a probability of the event occurring

### 1. Fuzzy Membership Function

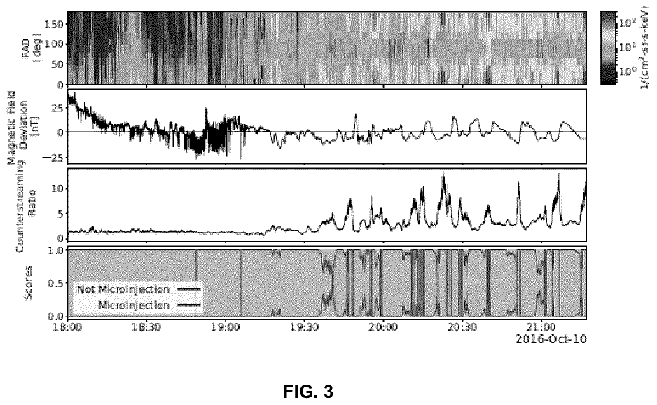

According to exemplary implementation of exemplary embodiments of the present disclosure, fuzzy membership function (FMF) is a function μ(x):X→[0, 1] which assigns a membership to each element x of a set X (see for example, and without limitation Zadeh, L. A., Klir, G. J., and Yuan, B., Fuzzy sets, fuzzy logic, and fuzzy systems: selected papers, Vol. 6, World scientific, 1996, the entire disclosure of which is incorporated herein by reference). The set of elements along with their associated memberships is called a fuzzy set. The FMFs for MEDOS are defined for each telemetry point associated with an event using a list of telemetry values and associated memberships. The FMF is then evaluated by interpolating between the telemetry-membership pairs. Continuing with the microinjection example, FIG. 2 shows an example of fuzzy membership function for the derived telemetry points discussed above (fuzzy definitions for (left) magnetic field deviation and (right) counterstreaming ratio). These fuzzy sets can be defined from knowledge of microinjections that is can be available in the literature or from SMEs.

### 2. Basic Belief Assignment

According to exemplary implementation of exemplary embodiments of the present disclosure, Dempster-Shafer theory introduces a mathematical system for the combination of evidence and reasoning under uncertainty (see for example, and without limitation Shafer, G., A Mathematical Theory of Evidence, Princeton university press, 1976; and Russell, S. J., and Norvig, P., Artificial intelligence: a modern approach, Pearson, 2022, the entire disclosures of which are incorporated herein by reference). Dempster-Shafer theory acts on a Frame of Discernment Θ, which is a set of mutually exclusive events Θ={θ₁, θ₂, . . . , θₙ}. The basic belief assignment (BBA) is then defined as any function m(A):2Θ→[0, 1] where A⊂Θ such that

$${\sum }_{A ⊆ Θ} m ( A ) = 1 , m ( ∅ ) = 0. \qquad ( 1 )$$

where m(A) measures the belief committed exactly to A. If m(A)>0, then A is called a focal element of Θ. If there is only one event in the A, then A is called a singleton focal element.

### 3. Belief Transforms

According to exemplary implementation of exemplary embodiments of the present disclosure, in order to obtain a BBA from a fuzzy set, a belief transform can be used. The normal BBA transform used for exemplary embodiments of the present disclosure

$${m}_{norm} ( \{ {θ}_{i} \} ) = μ ( {θ}_{i} ) / {\sum }_{j = 1}^{n} μ ( {θ}_{j} ) \qquad ( 2 )$$

where i=1, 2, . . . , n. The normal BBA transform acts only on the singleton focal elements, which was chosen to reduce the complexity of the calculation for space flight implementation. Alternative focal elements may result in improved detection efficiency, could be further explored, and are within the scope of the present disclosure.

In yet further exemplary implementation, once all BBAs are calculated, they can be combined to obtain the belief of each event. For this, we use Dempster's Rule of Combination. Given two basic belief assignments m₁ and m₂, and the associated focal elements A₁, A₂, . . . , Aₖ and B₁, B₂, . . . , Bₗ the combined BBA is defined as

$${m}_{demp} ( A ) = \frac{{\sum }_{\begin{matrix}i , j \\ {A}_{i} ⋂ {B}_{j} = A\end{matrix}} {m}_{1} ( {A}_{i} ) {m}_{2} ( {B}_{j} )}{1 - {\sum }_{\begin{matrix}i , j \\ {A}_{i} ⋂ {B}_{j} = ∅\end{matrix}} {m}_{1} ( {A}_{i} ) {m}_{2} ( {B}_{j} )} . \qquad ( 3 )$$

### 4. Pignistic Probability Transform

To convert the Dempster BBA into an actionable value, a pignistic probability transform is used. The pignistic probability is the probability that a rational person would assign to the event. There are many probability transforms to choose from (see for example, and without limitation Pan, W., and Yang, H., “New Methods of Transforming Belief Functions to Pignistic Probability Functions in Evidence Theory,” 2009 International Workshop on Intelligent Systems and Applications, 2009, pp. 1-5. https://doi.org/10.1109/IWISA.2009. 5072973., the entire disclosure of which is incorporated herein by reference). In exemplary embodiments of the present disclosure, the transform that can be chosen is:

$$BetP ( θ ) = {\sum }_{θ ∈ A ⊆ Θ} \frac{m ( A )}{\vert A \vert} \qquad ( 4 )$$

According to other example implementations within the scope of the present disclosure alternative pignistic probability transforms may result in improved detection efficiency and could be further explored.

### 5. Computational Complexity

Dempster's Combination Rule is #P-Complete, which is usually problematic for decision problems. However, in system according to exemplary implementation of example embodiments of the present disclosure the frame of discernment Θ is usually small (2-3), so this is not a limiting factor in the decision computation. Additionally, in example implementations, MEDOS can be configured to use only singleton focal elements, which reduces the complexity to linear with respect to |Θ| (see for example, and without limitation Barnett, J. A., Computational Methods for A Mathematical Theory of Evidence, Springer Berlin Heidelberg, Berlin, Heidelberg, 2008, pp. 197-216. https://doi.org/10.1007/978-3-540-44792-4_8, URL https://doi.org/10.1007/978-3-540-44792-4_8., the entire disclosure of which is incorporated herein by reference).

### C. Non-Limiting Example

To demonstrate the derived telemetry, feature extraction, and event detection, FIG. 3 (an example event detection of a magnetospheric microinjection) shows an example of how MEDOS can detect microinjections according to example implementations of example disclosed embodiments. The top panel shows the pitch angle distribution of electrons in the range of 70-600 keV. The second and third panels show the derived telemetry points of magnetic field deviation and counterstreaming ratio discussed in Section I.A. The fourth panel shows the MEDOS scores, computed using the event detection process discussed in Section I.B. As shown, MEDOS can successfully detect the microinjections when counterstreaming electrons occur within troughs of the magnetic field.

### II. Example Use Cases

While the initial need for the technology of example disclosed embodiments has been in satellite event detection and related response, several other areas with similar, or related needs are within the scope of the present disclosure. Such as, for example and without limitation, the following.

### A. Terrestrial Vehicles

Any vehicle can easily utilize MEDOS for event detection and operational response. Several examples include:
Marine systems such as surface ships or underwater, autonomous submersible systems.
Military vehicles operating in hostile environments.
Navigating disaster areas such as earthquakes, major storms, etc.
Mining and mineral extraction vehicles.
Navigating in caves, or other subterranean environments.

### B. UAS Offensive/Defensive Operations

With the increasing prevalence of unmanned aerial systems (UAS), it is becoming increasingly important to identify these systems and to estimate their intent. Offensively, it represents a key advantage if UAS can adapt to a changing environment in real time. MEDOS can provide key utility for both offensive and defensive UAS such as:
Identify unknown aerial vehicles and categorize them as friendly, hostile, or benign (e.g. a bird)
Identify swarming behaviors of multiple UAS in a scene
Predict path of UAS
Adapt to a changing target location
Identify new targets of opportunity.

### III. Non-Limiting Summary/Conclusion

Spacecraft operations can be challenging. When complex mission scenarios require operational responsiveness to an ever changing environment, it can be exceedingly difficult to plan spacecraft operations in advance. This difficulty is exacerbated when missions are far from Earth, with spotty communication, or when larger constellations require planning of multiple assets simultaneously. While AI learning algorithms are enticing for long term autonomous operation of space flight missions, these are not yet at a place where they are ready to be deployed in operational missions.

MEDOS presents a key milestone on the path towards true autonomous operation. It encodes the intelligence of subject matter experts onto the spacecraft to create derived, physically meaningful data products on board, and then uses those data products, much in the same way a human engineer would do, to determine if an event has occurred. A final confidence is returned that allows the spacecraft to respond with an appropriate action based on the confidence of the stated event.

In addition to space flight operations, we have identified several key technological advancements have been identified in the areas of non-space vehicles, and unmanned aerial systems that are within the scope of the present disclosure.

While the present disclosure has been shown and described with reference to certain exemplary embodiments thereof, it will be understood by those skilled in the art that various changes in form and details may be made therein without departing from the spirit and scope of the embodiments of the present disclosure. Furthermore, any of the features or elements of any exemplary implementations of the embodiments of the present disclosure as describes above and illustrated in the drawing figures can be implemented individually or in any combination(s) as would be readily appreciated by skilled artisans without departing from the spirit and scope of the embodiments of the present disclosure.

In addition, the included drawing figures, FIGS. 1-3, further describe non-limiting examples of implementations of certain exemplary embodiments of the present disclosure and aid in the description of technology associated therewith. Any specific terminology and/or dimensions provided in the drawings, other than as explicitly stated above, are exemplary and provided to facilitate understanding, and not intended to limit the scope or content of the inventive design or methodology as understood by artisans skilled in the relevant field of disclosure.

Other objects, advantages and salient features of the disclosure will become apparent to those skilled in the art from the details provided, which, taken in conjunction with the annexed drawing figures, disclose exemplary embodiments of the disclosure.

The terms and corresponding labels referenced in the disclosure are listed below for convenience. As would be readily appreciated by skilled artisans in the relevant art, while these and other descriptive terms are used throughout this specification to facilitate understanding, it is not intended to limit any components that can be used in combinations or individually to implement various aspects of the embodiments of the present disclosure.
B−=Magnetic field vector
Ci=Count rate for sensor i
L-i=Look direction for sensor i
PA=Pitch angle
f∥=Parallel component of flux
f⊥=Perpendicular component of flux
DB=Magnetic field deviation
CR=Counterstreaming ratio
μ(x)=fuzzy membership function for a variable, x
Θ=Dempster-Shafer frame of discernment for set of events
θn=Individual event as part of set Θ
mi=Belief assignment, i
A, B=Focal elements associated with belief assignment, mi
L=L-shell of radiation belt
r=Radial distance from center of Earth to a field line
λ=Magnetic latitude
f( )=Phase space density
E=Energy
φ=Azimuth angle
θ=Elevation angle
n=Plasma density
F1=Ground calibration matrix for conversion to phase space density

1. A method comprising:
calculating derived parameters, said parameter being a physically meaningful quantity relevant for accounting of an event occurrence;
comparing said derived parameters to predefined parameter; and
producing a confidence value indicative of said event occurrence,
wherein the confidence value is presented as a likelihood of said even occurrence.

2. The method of claim 1, wherein
a derived telemetry feature fuses multiple telemetry streams together into said physically meaningful quantity; and
said comparing comprises detection of said event using fuzzy sets to determine said confidence value indicative of said event occurrence.
